(19) United States
(12) Patent Application Publication
(10) Pub. No.: US 2007/0234902 A1
(43) Pub. Date: Oct. 11, 2007

(54) METHOD FOR MERCURY REMOVAL FROM FLUE GAS STREAMS

(76) Inventors: David L. Fair, Imperial, PA (US); James D. McNamara, Pittsburgh, PA (US); Michael Greenbank, Monaca, PA (US)

Correspondence Address: Christine W. Trebilcock, Esq.;Cohen & Grigsby, P.C., 15th Floor, 11 Stanwix Street, Pittsburgh, PA, 15222-1319, US

(21) Appl. No.: 11/277,792

(22) Filed: Mar. 29, 2006

(51) Int. Cl. B01D 53/02

(52) U.S. Cl. 95/134

(57) ABSTRACT

The method for removing mercury from a flue gas stream of the present invention is comprised of first treating a sorbent with a metal halide, and then contacting a sufficient amount of the sorbent with a gas stream for a sufficient amount of time to bind with a desired amount of the mercury in said gas stream. The metal is selected from Groups I and II of the periodic table of the elements. The halide is selected from the group consisting of I, Br, Cl. The metal halide comprises from about 0.5% to 25% by weight of said treated sorbent.

### FIELD OF INVENTION

The invention relates to a method for removing mercury from the flue gas stream that results from the combustion of mercury containing materials using a modified carbonaceous sorbent. The invention will find particular utility at municipal waste incinerators and coal-fired power plants.

### BACKGROUND OF INVENTION

The Clean Air Act Amendments of 1990 required the U.S. Environmental Protection Agency (EPA) to study mercury emissions from combustion and other sources. It has been estimated that coal-fired power plants represent the largest source of airborne mercury emissions in the United States. The results from the coal-fired power plants showed that a certain level of mercury emission control was already achieved by the existing air pollution control devices (APCD). The extent of mercury removal at any given facility depended on a number of factors which included the type of coal used, fly ash composition, APCD technology employed, and other factors. Many existing APCD technologies will likely not be able to achieve the future mercury emission limits to minimize the public health concern of mercury accumulation in the environment, especially in salt-water fish. In March 2005, EPA issued a rule to reduce emissions of mercury from 48 tons per year to 38 tons in 2010 and to 15 tons in 2018, which is about a 70% average reduction in mercury emissions. Some states have proposed incrementing stricter mercury regulations, such as Pennsylvania's current proposal to cut emissions by 90% within a decade.

One of the most promising solutions for mercury removal from flue gas is Activated Carbon Injection (ACI). In ACI, powdered activated carbon is injected into the flue gas stream where it captures a portion of the mercury that is preset in the stream. The activated carbon with the captured mercury is then collected together with the fly ash by some type of particulate collection device. The flue gas, with a reduced mercury level, is then exhausted through the stack. Activated carbon is a highly porous, non-toxic, readily available material that has a high affinity for mercury vapor. ACI technology is already established for use with municipal incinerators, but is only in trials for use at power plants. Compared to municipal waste incinerators, the flue gas from coal-fired power plants contains a lower mercury level and has a different flue gas chemistry. Sorbents appropriate for the power plant application must be capable of binding mercury when injected into the emissions and performing well even under these different conditions. Although the ACI technology has been shown to be effective for mercury removal, many of the methods currently used may not achieve desired percent reduction in mercury emission without significant cost or possible lack of availability of appropriate sorbent materials. A high injection rate of 10-20 pounds of sorbent per 1 million actual cubic feet of flue gas of sorbents may be necessary in prior methods to achieve an ultimate target of 70% or 90% mercury removal in a coal-fired power plant. Such high rates, especially near or even above 20 pounds, however, would tax the capability of most injection equipment and require a significant amount of sorbent, preferably inexpensive sorbent to be economical. Therefore there is a need for a mercury removal process that can achieve the 90% mercury removal at reasonable injection rates. There is also a need for a method that utilizes sorbents that can be made without having to handle hazardous chemicals. They also need to be easy and economical to produce in large quantities.

In the past, activated carbons that have been impregnated with halides and halide salts, have been shown to have an affinity to capture mercury. Activated carbon has been impregnated with KI₃ for the removal of mercury vapor from gases as shown in U.S. Pat. No. 3,194,629, and by the use of a carbon molecular sieve material that is impregnated with KI₃ as disclosed in U.S. Pat. No. 4,708,853. However, performance is only recognized with mercury vapor saturated air under ambient conditions, or saturated air at 20° C., respectively. Alternatively, in U.S. Pat. No. 4,500,327, activated carbon has been impregnated with sulfur or a sulfate compound together with another compound for the removal of mercury vapor from a gas stream, but the impregnated activated carbons were only exposed to mercury vapor at 25° C. carried in stream of nitrogen.

Activated carbon has also been impregnated with metal halides for removing mercury from liquid hydrocarbons as in U.S. Pat. No. 5,336,835. The use of these prior carbons is limited to liquid streams. None mention how the sorbents would perform in a gas phase system such as a flue gas stream.

To address the concerns of flue gas streams, metal halides and reactive materials such as Br₂, HBr, and sulfur have been used as impregnants on activated carbon. In U.S. Pat. No. 6,638,347, El-shonbary et al. use cupric chloride with metal halides for the removal of mercury from a high temperature, high moisture gas stream from incinerating contaminated soil. KI and KI₃ are mentioned as additives that can be used together with the cupric chloride. The author realizes that the performance of any given sorbent is dependant on moisture content and temperature of the gas stream. Different sorbents perform differently as variables such as moisture content, temperature, contact time, and flue gas chemistry change from on application to the next. The effect of any of these variables on a given sorbent under a given set of conditions is unpredictable.

In U.S. Pat. No. 6,719,828, Lovell et al. recognize the performance of activated carbon for flue gas applications is varied and unpredictable: “Activated carbon injection ratios for effective mercury control are widely variable and also explained by the dependence of the sorption process on flue gas temperature and composition, mercury speciation and also fly ash chemistry.” (column 3, lines 14-18). “Activated carbon lost sixty-three percent of its sorption capacity in the presence of sulfur dioxide and nitrogen dioxide in the feed gas stream.” (column 31, lines 41-43). “In the presence of both sulfur dioxide and nitrogen oxides, Darco carbon showed virtually no capacity to absorb mercury.” (column 33, lines 18-20). Their solution proposes the use of a chemically treated vermiculite for the removal of mercury from a flue gas stream.

U.S. Pat. No. 6,848,374 discloses the use of pulverized coal particles as mercury sorbent for a flue gas stream. The author states that sorbent can be treated with metal halides, halogens, and halogen acid to enhance performance of the sorbent. The outer surfaces of the coal particles are first oxidized before the application of the various chemicals. However, a problem with coal particles is their high density. As a result, the particles would quickly settle out of the flue gas stream rather than staying finely dispersed. The low surface area of the particles would also lead to much lower removal efficiency.

U.S. Pat. No. 6,953,494 teaches the use of elemental bromine (Br₂) and hydrogen bromide (HBr) to produce a modified activated carbon that has enhanced mercury sequestration from hot combustion gas streams. The author claims that these compounds chemically react with the activated carbon and therefore will not off-gas during use. The author does concede that at loadings above 15 wt % Br₂ some degree of bromine may evolve off under some conditions. This could lead to corrosion of downstream structures. Moreover, the preparation of this sorbent requires the handling of elemental bromine or hydrogen bromide. These materials are either gases or fuming liquids which require special storage and handling. They also require special worker protection since these materials present serious respiratory hazards.

U.S. Pat. No. 6,960,329 teaches the use of chloride salts for mercury removal from a hot flue gas stream. This technology simply sprays an aqueous solution of the salt into the exhaust system of the power plant to convert elemental mercury into mercury chloride. The chloride salts include ammonium chloride, sodium chloride, potassium chloride, and calcium chloride. No sorbent material is used.

A paper from the US DOE/NETL¹ evaluated the mercury capacities of a number of impregnated sorbents as packed beds using a stream of mercury vapor in either argon or air. Some of the results of this study illustrate the many variables that can influence the performance of any given mercury sorbent. In one example with a sulfur impregnated sorbent and argon gas carrier, the temperature is increased from 280° F. to 350° F. The result of the higher temperature was to reduce the mercury capacity of the sorbent by almost 90%. Adjusting the carrier gas from argon to air (at 280° F.) resulted in an 85% decrease in the mercury capacity of the sorbent. These evaluations were conducted in a laboratory so it is not known how any of these sorbents would perform at an actual power plant. However, the tests do show significant effects by slight changes in the conditions. Although there is no direct translation between these results and performance in a power plant, they illustrate how seemingly small changes in one variable can dramatically influence the mercury capacity of a sorbent.

Tests have been conducted where in-flight testing was performed with actual flue gas from a coal-fired power plant. The results were unpredictable. A standard, non-impregnated FluePac carbon from Calgon Carbon Corporation showed 60%-70% mercury removal. This material is a powdered activated carbon with an iodine number around 800. However, a sulfur impregnated carbon that has been used commercially for mercury removal from natural gas only showed 6%-7% mercury removal from the same flue gas stream. Although sulflir is kIown to be reactive with elemental mercury, the results evidenced a significant decrease in performance.

Although the prior art contains various examples of the use of metal halide salts for mercury vapor removal from a gas stream, there is no example of a method for using a metal halide impregnated carbonaceous sorbent that has proven performance in a hot combustion-gas stream. The above examples illustrate how the performance of a given mercury sorbent under one set of conditions does not indicate the performance of that same sorbent under real, coal-fired power plant, flue gas conditions. In some cases the actual results are the opposite of what one would have predicted from previous experience. The prior art has not been able to successfully predict the best sorbents for this application. The effects of temperature (300° F.), moisture level, oxygen content, short contact time (2 seconds), and presence and level of acid gases makes the performance of any given sorbent very uncertain at best. Therefore there is a need for sorbents that can achieve a 90% mercury removal at reasonable injection rates, i.e., those below 10 pounds of sorbent per 1 million actual cubic feet of flue gas. There is also a need for high efficiency sorbents that can be made without having to use heavy metals or to handle hazardous chemicals. The sorbents should be easy and economical to produce in large quantities.

### SUMMARY OF INVENTION

The present invention relates to a method for removing mercury from a flue gas stream. A first step of the method involves treating a sorbent with a metal halide. A second step requires contacting a sufficient amount of the treated sorbent with the gas stream for a sufficient amount of time to bind with a desired amount of the mercury in the gas stream.

In the first step, a variety of sorbents can be used including activated carbon, carbon chars, thermally activated organic materials such as coal, wood, etc., or tire pyroylsis products. A preferred carbonaceous sorbent of this invention is activated carbon. In an example, the sorbent comprises a reactivated spent carbon. Spent carbon is collected from municipal water treatment units and other filtration systems that produce used carbons. The spent carbon is subjected to high temperatures that burn-off contaminants sufficient to restore adsorbent sites so they are capable of binding mercury in a gas stream. Appropriate sorbent reactivated carbon has at least an iodine number of 600. The method efficiency improves using sorbents having iodine numbers of at least 750-850 and greater. Use of reactivated spent carbon further provides an outlet for otherwise used-up carbon and saves facilities the cost of purchasing virgin carbon to achieve desired levels of mercury reduction.

The metal is selected from Groups I and II of the periodic table of the elements and the halide is selected from the group consisting of I, Br, Cl. The metal halide comprises about 0.5% to 25% by weight of the treated sorbent. In an example, the metal halide comprises about 1% to 7% by weight of the treated sorbent.

The sorbent is treated by dissolving a metal halide salt in water, and applying the resulting solution to the sorbent. The impregnant solution can, in one case, be applied to the sorbent as a spray. The sprayed impregnant is absorbed therein. When the sorbent is dried, the water is driven out of the sorbent, the impregnant remains inside the sorbent pores, such as in an activated carbon particle. In another example, dry activated carbon is soaked in halide salt solution. As it soaks, air migrates out of the carbon, and is replaced with impregnant solution. The water is driven out of the carbon and the impregnant is left behind inside the activated carbon particles. A third example involves soaking an already wet activated carbon in a halide salt solution. The water already in the carbon will equilibrate with the halide salt solution. Again the wet activated carbon is dried to produce the impregnated, activated carbon. The impregnated sorbent can be used in a wet or dry form. Use of activated carbon takes advantage of the enormous surface of activated carbon and the power of the adsorption pores to dramatically increase the rate of adsorption of the mercury vapor. No surface oxidation step is needed with the current invention.

Alternatively, the halide salt impregnation can also be accomplished using the above described methods together with an industrial waste brine stream. The use of this waste stream reduces the cost of the impregnated sorbent. This technique produces a halide salt impregnated sorbent that is effective for mercury removal from a flue gas stream. The impurities that are often present in an industrial waste brine stream are not believed to interfere with the performance of the impregnated sorbent.

In the second step, a flue gas stream is contacted with a treated sorbent. Contact is conducted by continuously injecting sorbent into the gas stream. Sorbent is injected for an amount of time that is sufficient for the sorbent to bind with a desired amount of the mercury in the gas stream. This time is determined based upon the amount of sorbent adjusted to accommodate the flow of flue gas being exhausted, and the distance that gas stream travels from the point of sorbent injection to the point of the facility's filtration collection system. Generally, a shorter distance requires injection of a greater amount of sorbent to ensure there is sufficient contacting with the stream. The stream exhausted from the facility is measured and contacting is sufficient when desired mercury reduction is measured in the exhaust. However, even having a further distance, sorbent that is injected into a gas stream traveling at a relatively fast rate will have less contact time with the stream. A greater amount of sorbent may be necessary to achieve desired mercury reduction. Ideal amounts and exposure times may vary depending upon the facility layout and construction. Considering facility particulars and desired mercury reduction levels, method step two is adjusted and conducted until those levels are achieved.

Alternatively or additionally, in certain situations, sorbent is dosed into the stream. A shot of sorbent is injected into the stream and deposited on the fabric particulate filter bag. The filtration system holds the sorbent for a time to enable further contacting with the stream. Dosing may be administered intermittently or pulsed upon need.

The method enhances mercury removal by use of carbonaceous sorbent that is impregnated with a metal halide consisting of the halides of I, Br, and Cl. Although metals from Groups I and II of the periodic table are preferred, any metal from the periodic table of the elements can serve as the “vehicle” for deposition of the I, Br, or Cl on the carbonaceous sorbent. The preferred halides are Br and I. The preferred metal is potassium. In an example, the method uses a carbonaceous sorbent impregnated to contain a final composition by weight of metal halide from 0.5% to 25%.

The fact that this method is conducted in a gas phase, high temperature (300° F.), short contact time (2 seconds) application has resulted in poor performance or failure of some mercury sorbents that have worked well in other applications. The complexities of the flue gas chemistry (SOₓ, NOₓ, HCl, H₂O, O₂) have also led to the poor performance of mercury sorbents that have worked well under other conditions. Some components can compete with the mercury for available adsorption sites. In other cases, mercury reactive sites in the sorbent can be deactivated by acid gases or oxygen.

The authors were surprised to learn that this method of contacting flue gas with metal halide impregnated sorbents was effective because, based on prior art, halide salts are not reactive materials, such as Br₂ and HBr. However, not only has the method been shown to be effective for mercury removal, but in some instances it could even achieve a 90% mercury removal objective at normal injection rates. It was also surprising that the method could achieve a relatively high level of mercury removal using some of the less expensive metal halides (e.g., KBr) could be used at economical levels (e.g., 2 wt % loading).

Another advantage of the present invention is that it provides a method for achieving significant mercury removal using non-hazardous sorbents at reasonable injection rates of 1 to less than about 10 pounds of sorbent per million actual cubic feet of flue gas. Additionally the method uses sorbents that can be easily produced in large quantities and economically. The prior art has shown that the performance of a mercury sorbent for this application can only be predicted if tested using an actual flue gas stream. The in-flight testing that was used with the sorbents of the current invention is accepted in the industry as the best available predictor of performance for this application. The use of non-hazardous, non-volatile, metal halide salts avoids the use of hazardous gaseous materials, such as Br₂ and HBr, required in prior art methods. Other features and advantages of the invention will become apparent from the detailed description, examples and claims.

### DETAILED EXAMPLES OF EMBODIMENTS OF THE INVENTION

To prepare an impregnated activated carbon sorbent, an untreated sorbent, DSR-A (8×24 mesh, 800 iodine number), was sprayed with either a 2% or 5% aqueous sollution of KBr or KI to produce the desired metal halide loading. Four samples were prepared to have one of each of these concentrations of metal halide solution. Each sample of the wet, impregnated sorbent was then dried at 160° C. for about two hours and ground to a powder (95%-325 mesh). The treated sorbent was then contacted with a flue gas stream. The mercury removal capability of the powdered sorbents were then determined using in-flight testing with a slipstream from a flue gas stream from a commercial power plant. The volume of the slipstream was 30-50 acfm. The temperature of the slipstream was maintained at about 300° F. using a computer controlled system of heat tapes and thermocouples. The composition of the slipstream will vary as the composite of the flue gas from the plant changes. This can be seen in the different initial mercury concentrations with the various sorbents. When the improvement in mercury removal is greater than 5%, these variations become less significant.

To conduct this testing, a small, metered amount of the sorbent (0.05-0.10 grams/minute) is injected into a flowing stream of the flue gas. Samples of the treated flue gas are extracted after 2 seconds contact time and analyzed for the percent of mercury removed from the flue gas stream. A mercury analyzer is used to determine (in real time) how much mercury is being removed from the flue gas stream. Typical contact times in a commercial power plant range about 2-4 seconds before the particulates are removed by a particulate collection device.

Table I shows a summary of the results. The results show the current inventive method has improvements on the order of 20% over methods using the untreated baseline material. All sorbent samples were 95% -325 mesh. An injection rate of 8 pounds of sorbent for 1 million actual cubic feet of flue gas was used. A sufficient range for injection rates for mercury sorbents ranges from 1 to less than about 10 pounds of sorbent for 1 million actual cubic feet of flue gas.

TABLE I

| | Mercury Concentration μg/m³ | | |
|---|---|---|---|
| Sorbent | Initial | Final | Mercury Removed |
| DRS-A (untreated) | 6.2 | 1.7 | 73% |
| DSR-A 2% KBr | 5.8 | 0.37 | 94% |
| DSR-A 5% KBr | 5.2 | 0.34 | 93% |
| DSR-A 2% KI | 5.2 | 0.80 | 85% |
| DSR-A 5% KI | 3.2 | 0.28 | 91% |

As can be seen in Table I, the untreated sorbent is unable to reach the 90% mercury removal objective. Three of the metal halide impregnated sorbents were able to reach and exceed the 90% mercury removal objective using less than 10 pounds of sorbent for 1 million actual cubic feet of flue gas. These sorbents have also achieved the mercury removal objective using a commercial flue gas stream at real operating temperatures (300° F.), real contact times (2 seconds), and real flue gas chemistry.

While the foregoing has been set forth in considerable detail, it is to be understood that the examples and detailed embodiments are presented for elucidation and not limitation. Method variations, especially in matters of solution concentrations and means of preparation of the impregnated carbon, may be made but are within the principles of the invention. Those skilled in the art will realize that such changes or modifications of the invention or combinations of steps, variations, equivalents, or improvements therein are still within the scope of the invention as defined in the appended claims.

What is claimed is:

1. A method for removing mercury from a flue gas stream comprising:
(a) treating a sorbent with a metal halide wherein said metal is selected from Groups I and II of the periodic table of the elements and said halide is selected from the group consisting of I, Br, Cl, said metal halide comprising from about 0.5% to 25% by weight of said treated sorbent; and
(b) contacting a sufficient amount of said treated sorbent with said gas stream for a sufficient amount of time to bind with a desired amount of the mercury in said gas stream.

2. The method of claim 1, wherein the sorbent is a carbonaceous sorbent.

3. The method of claim 1, wherein the sorbent is an activated carbon.

4. The method of claim 1, wherein the metal halide is selected from the group consisting of potassium bromide, lithium bromide, and sodium bromide.

5. The method of claim 1, wherein the metal halide is selected from the group consisting of potassium iodide, lithium iodide, and sodium iodide.

6. The method of claim 1, wherein the impregnated sorbent is produced by contacting the base sorbent with a waste brine stream.

6. The method of claim 1, wherein the flue gas stream comes from a municipal waste incinerator or coal-fired power plant.

8. The method of claim 1, wherein the flue gas stream is comprised of carbon dioxide, nitrogen, oxygen, water, hydrogen chloride, sulfur oxides, nitrogen oxides, elemental mercury, and oxidized mercury species.

9. The method of claim 1, wherein the temperature of the flue gas stream is approximately 300° F.

10. The method of claim 1, wherein said amount of time to bind the sorbent ranges from about 2-4 seconds.

11. The method of claim 1, wherein said amount of sorbent is about 1 to less than about 10 pounds of sorbent per 1 million actual cubic feet of flue gas.

12. The method of claim 1, wherein said amount of sorbent is about 10 pounds of sorbent or greater per 1 million actual cubic feet of flue gas.

13. The method of claim 1, wherein the sorbent is a reactivated spent carbon.

14. The method of claim 1, wherein the sorbent has an iodine number of about 750 to 850.

15. The method of claim 1 wherein said contacting requires continuously injecting said treated sorbent into said gas stream.

16. The method of claim 1 wherein said contacting requires intermittently injecting said treated sorbent into said gas stream.

17. The method of claim 1 further comprising step (c), comprising extracting a sample of said contacted gas stream and analyzing said sample for the percent of mercury removed from said contacted gas stream.
